(19) United States
(12) Patent Application Publication
(10) Pub. No.: US 2022/0107681 A1
(43) Pub. Date: Apr. 7, 2022

(54) USER INTERACTIONS IN VIRTUAL REALITY

(71) Applicant: Hewlett-Packard Development Company, L.P., Spring, TX (US)

(72) Inventor: Maikel Maciel Ronnau, Porto Alegre (BR)

(73) Assignee: Hewlett-Packard Development Company, L.P., Spring, TX (US)

(21) Appl. No.: 17/418,994

(22) PCT Filed: Jun. 25, 2019
(86) PCT No.: PCT/US2019/038988

§ 371 Date: Jun. 28, 2021

(51) Int. Cl. G06F 3/01; G06T 13/40; G06T 17/00; G06T 7/20; A63F 13/52

(52) U.S. Cl. CPC G06F 3/011; G06T 13/40; G06T 17/00; G06T 7/20; A63F 2300/8082; G06T 2207/10024; G06T 2207/30196; G06T 2200/08; A63F 13/52

(57) ABSTRACT

A virtual reality (VR) system for providing real time user interaction includes at least one red, green, blue (RGB) camera to capture image data of a user's body in a physical environment, a processor to receive the image data to formulate a 3D model of the user's body and to map the 3D model inside a VR environment, and a head-mounted display (HMD) to display the 3D model and movements of the 3D model within the VR environment.

### BACKGROUND

Virtual reality (VR) provides a simulated environment that can be quite similar or vastly different from the real world. Instead of viewing a screen in front of them, users are immersed and able to interact in three-dimensional (3D) worlds. Simulating a physical presence in a real or imaginary world is one of the major aspects of virtual reality and this ability has taken the gaming industry among other fields to a heightened level of the senses. The technology is new and innovative and provides many different types of experiences that are both safe and enjoyable and which further allow easy remote access.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1a illustrates a user being recorded by a camera according to an example of the principles described herein.

FIG. 1b illustrates a model created from a user being recorded by a camera according to an example of the principles described herein.

FIG. 2a illustrates a user playing a soccer game and being recorded by a camera according to an example of the principles described herein.

FIG. 2b illustrates a model playing a soccer game in a virtual environment according to an example of the principles described herein.

FIG. 3a illustrates two users equipped with a portable backpack and a head-mounted display (HMD) and being recorded by a camera according to an example of the principles described herein.

FIG. 3b illustrates a single user equipped with a portable backpack and an HMD being recorded by a camera according to an example of the principles described herein.

FIG. 4a illustrates the users represented as 3D models in a virtual environment according to an example of the principles described herein.

FIG. 4b illustrates the users represented as 3D models in a virtual environment according to an example of the principles described herein.

FIG. 5 illustrates users in a virtual classroom setting according to an example of the principles described herein.

FIG. 6 illustrates users in a collaborative business setting according to an example of the principles described herein.

FIG. 7 illustrates users in a blended reality environment according to an example of the principles described herein.

FIG. 8a illustrates individuals being tracked from a source image according to an example of the principles described herein.

FIG. 8b illustrates processing of individuals being tracked from a source image according to an example of the principles described herein.

FIG. 8c illustrates body parts to be used to create a 3D model according to an example of the principles described herein.

FIG. 8d illustrates a rendering of textures applied to 3D models according to an example of the principles described herein.

FIG. 8e illustrates a rendering of textures applied to 3D models within a virtual environment according to an example of the principles described herein.

FIG. 8f illustrates textures to be applied to a 3D model.

FIG. 9 illustrates a process for creating a 3D model.

FIG. 10 illustrates a diagram of a VR system according to an example of the principles described herein.

FIG. 11 illustrates a flow diagram of a method for providing user interaction in VR with 3D models.

Throughout the drawings, identical reference numbers designate similar, but not necessarily identical, elements.

### DETAILED DESCRIPTION

In the following description, for purposes of explanation, specific details are set forth in order to provide a thorough understanding of the disclosure. It will be apparent, however, to one skilled in the art that examples consistent with the present disclosure may be practiced without these specific details. Reference in the specification to “an implementation,” “an example” or similar language means that a particular feature, structure, or characteristic described in connection with the implementation or example is included in at least that one implementation, but not necessarily in other implementations. The various instances of the phrase “in one implementation” or similar phrases in various places in the specification are not necessarily all referring to the same implementation.

The preceding description has been presented only to illustrate and describe examples of the principles described. This description is not intended to be exhaustive or to limit these principles to any precise form disclosed. Many modifications and variations are possible in light of the above teaching.

Users typically rely on multiple gesture hardware to interact within a virtual reality (VR) environment. For example, control devices that are maneuvered with hands are relied on to track hand movements of the user. A control device may further be used for head tracking and eye tracking. Multiple devices may be used to track different parts of the body. None of the current solutions provide accurate full body tracking.

Furthermore, typically one or more depth cameras are used to generate a model of the user. The depth cameras must be positioned directly in front of the user to ascertain the range of area in which a user can move. Three-dimensional (3D) data captured by the depth cameras is used to create 3D vectors of various widths, heights, and distances of the user's body structures from the sensor. Each body part may be characterized as a mathematical vector defining joints and bones of a skeletal model.

Red, green, blue (RGB) cameras in conjunction with a sensor (e.g., depth camera, a second RGB camera, etc.) may also be used to obtain skeletal models. A color image is expressed in pixel form and a matrix is used to correlate each pixel in the image to a value that represents the distance of the pixel from the sensor. In this manner, the body of a user playing an on-screen character (e.g., avatar, etc.) can be tracked and a skeletal model may be used to model the user as the on-screen character. Current processing requires multiple steps such as estimations, interpolations, and extrapolations from the data to accomplish any meaningful representation which can be inaccurate and inefficient.

The following provides human interaction in VR by replacing gesture tracking devices with 3D real time tracking. A single RGB camera may be used to provide a new level of interaction that can completely or nearly completely remove the need of handheld control devices during play time. Instead of a skeletal vector-based model, image mapping in real-time provides a 3D surface representation model. The tracking information provided can cover the whole body and provide the necessary input from the user to properly interact in VR with both simple (e.g., waving arm, leg lift, etc.) and complex body movements (e.g., throwing a ball, dance movement, etc.). The user's whole body can be captured rather than line-based frames associated with skeletal vector-based models or partial body models or models that depend on multiple devices. Images captured within a physical environment are used to map one or more 3D surface representation models within a VR environment.

“Virtual reality” (VR), as used herein, is an interactive experience that immerses users in a fully artificial digital environment. The digital environment provides a simulated environment that can be similar to or completely different from the real world. Applications of virtual reality can include entertainment (i.e., gaming) and educational purposes (i.e. medical or military training).

“Augmented reality” (AR), as used herein, is an interactive experience that overlays virtual objects on the real world environment. Objects that reside in the real-world are enhanced by computer-generated perceptual information that can be constructive (e.g., additive to the natural environment, user, object, etc.), or destructive (e.g., masking of the natural environment, user, object, etc.). In this way, augmented reality alters one's ongoing perception of a real-world environment, whereas virtual reality completely replaces the users real-world environment with a simulated one. Immersive perceptual information is sometimes combined with supplemental information like scores over a live video feed of a sporting event.

“Mixed reality” (MR), as used herein, denotes the merging of real and virtual worlds to produce new environments and visualizations. Physical and digital objects co-exist and interact in real time. Users can interact with both the real world and the virtual environment. MR takes place not only in the physical world or the virtual world, but is a hybrid of reality and virtual reality, encompassing both augmented reality and augmented virtuality via immersive technology.

Each environment can be compared and contrasted to further differentiate them from each other. In MR and AR, virtual objects behave based on the user's perspective the real world. In VR, virtual objects change their position and size based on the user's perspective in the virtual world. In MR and VR, perfectly rendered virtual objects can't be distinguished from real objects. In AR, virtual objects can be identified based on their nature and behavior, such as floating text that follows a user. In AR and MR, a combination of computer-generated images and real life objects are used. In VR, computer graphics are generated by a computer. In VR, head-mounted displays (HMDs) are used. In AR/MR, HMDs can be used as well as holodisplays, head up technology, and other viewing technology.

While reference is made to one or more of the environments throughout the description, it is to be understood that each environment is interchangeable according to principles discussed herein.

A “head-mounted display” (HMD), as used herein, includes a display device worn on the head. It may be part of a helmet, a set of goggles, or other head supported device. The HMD includes a small display optic in front of one or each eye. Variations of an HMD are also anticipated, such as an optical HMD, which include a wearable display that can reflect projected images and allow a user to see through it.

An example VR system for providing real time user interaction according to principles discussed herein includes at least one RGB camera to capture image data of a user's body in a physical environment. A processor receives the image data to formulate a 3D model of the user's body and then maps the 3D model inside a VR environment. An HMD displays the 3D model and movements of the 3D model within the VR environment. In this manner, a whole host of opportunities awaits the user in the form of the 3D model in worlds without end.

An example method of providing real time user interaction in an AR environment according to principles discussed herein includes the use of 3D tracking to capture image data of the user's body in a physical environment. The method further includes formulating a 3D model of a user's body with the image data, mapping the 3D model inside an AR environment that is visible to a user wearing an HMD, and replicating at least one body movement of the user using the 3D model within the AR environment.

An example non-transitory computer readable medium according to principles discussed herein includes usable program code to, when executed by a processor, use 3D tracking to capture image data of the user's body in a physical environment, formulate a 3D model of a user's body with the image data, map the 3D model inside a VR environment, and replicate at least one or more body movements of the user using the 3D model within the VR environment. The 3D model and VR environment are visible to a user wearing an HMD.

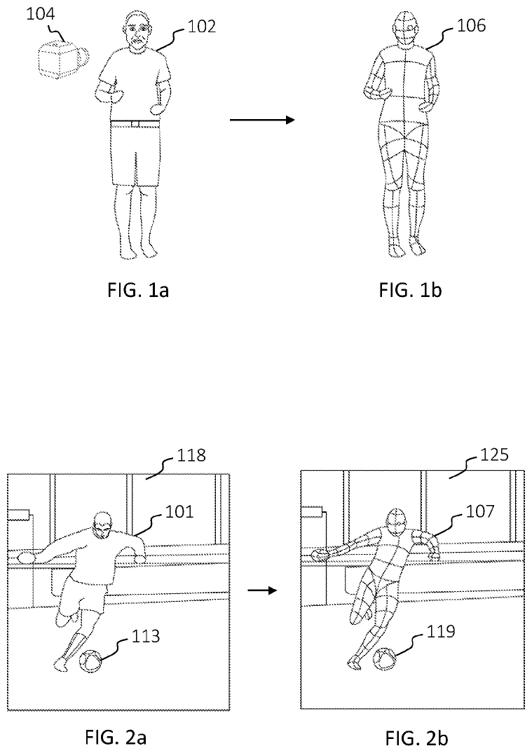

Turning to FIG. 1a, a user 102 is shown standing near an RGB camera 104 that is angled toward the user 102. The RGB camera 104 captures images of the user's entire body or parts of the user's body. The images captured are used to form a 3D model, such as a mesh model or a 3D surface representation model. The 3D model 106 as shown in FIG. 1b includes the model of a generic user or the actual user 102 or a combination thereof. The 3D model 106 includes a representation of a body and represents basic structures such as arms, legs, head, trunk. The 3D model 106 can be developed by adding body parts from the images and textures to form avatars that are placed within a virtual environment. This technique provides users with a much more accurate or imaginative alternative representation of themselves within VR systems because their whole body is an interactive agent since the tracking comprehends the whole body. Users can count on movements from their legs, arms, feet, etc., to play games with deeper levels of immersion.

As shown, the RGB camera 104 is positioned at an angle in FIG. 1a. The RGB camera 104 is “strategically positioned,” or in other words, positioned to capture a desired position of the user's entire body or parts of the user's body for mapping the desired body parts to a 3D model. A strategic position may further include capturing other users in the environment in addition to the user 102 shown.

An RGB camera may be placed directly in front of the user but is not restricted to being placed directly in front of the user like common image acquisition tracking systems, and may instead be angled to get different sides of the user's body. For example, an RGB camera may be placed in an upper corner of a square room because the image capture being relied on does not require frontal placement. In this way, the user has much more freedom than when using traditional forms of capture. For example, a user's movements of turning around are easily captured with an RGB camera having a range of placements. Also, users that are standing one in front of the other are not hidden from a corner placement of the camera like they would be from cameras placed directly in front of the users that use other techniques.

Other placements of an RGB camera besides corner placements are anticipated. For example, an RGB camera may be strategically positioned directly in front of the user like traditional capture or on top of the ceiling facing down on top of the user's body. The RGB camera may be strategically positioned at a side of the room to provide a side stance of the user. Other placements are also anticipated.

Note that additional RGB cameras may also be used to create the 3D models. Furthermore, other types of tracking cameras and devices may be used to create the 3D models. For example, depth cameras, 3D cameras, movement sensors, and other devices that are used in motion capture may be used.

FIGS. 2a and 2b illustrate an example mapping procedure according to principles discussed herein. In FIG. 2a, a user 101 is shown kicking a soccer ball 113 in a physical environment 118 represented as an indoor soccer field and being tracked by an RGB camera not shown. In FIG. 2b, the image data from FIG. 2a is used to render a 3D model 107 of the user kicking a 3D model of the soccer ball 119 in a duplicate physical environment 125 of the soccer field in the FIG. 2a.

Note that inanimate objects such as balls and other objects can be made into 3D models. The virtual environment can be the same or different than the original environment. The tracked image data can be manipulated and rendered inside the VR environment to simulate a movement that is representative or nearly identical to that of the user 101 or whatever is being tracked.

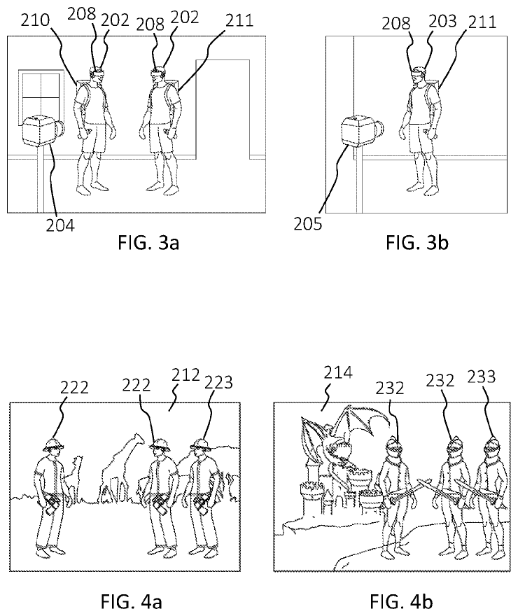

Users can further benefit from HMDs that enables users to see themselves within the VR environment. Turning to FIG. 3A, users 202 are shown wearing HMDs 208 and donning VR backpacks 211. An RGB camera 204 is positioned at an angle toward the users 202. The advantage of the VR headgear 208 is that they enable the user freedom to move around and not be limited to a single screen and a single room. For example, RGB cameras could be placed strategically throughout a house and the users could move freely throughout the house to engage in a virtual experience.

A VR backpack or other VR portable device may contain, for example, a processor that processes the image data. A battery may also be contained in the VR backpack to power the VR system for maximum portability. The user may thus carry the entire system on his body and can freely move around from place to place and from one location to another location and from one RGB camera in one location to another location having a different RGB camera.

FIG. 3b illustrates a user 203 located in a separate physical environment from users 202 as indicated by the separate box and a separate RGB camera 205. The user 203 is wearing an HMD 208 and dons a VR backpack 211 and can fully participate in the same VR experience as users 202 in FIG. 3a. The image data captured by RGB cameras 204 and 205 can be merged such that 3D models 222 and 223 of respective users 202 and 203 are placed within the same virtual environment in which they can see each other and interact with each. This eliminates the need for users 202 and 203 to be in the same physical environment in order to be in the same virtual environment.

As an alternative, the users 202 and 203 may see each other as 3D models 232 and 223 in a VR environment but not the same VR environment as each other. For example, FIG. 4a illustrates a jungle scene 212 while FIG. 4b illustrates a medieval castle scene 215. Users 202 may see the jungle scene while user 203 sees a medieval castle scene 214. The users 202 and 203 may thus have differences in the type of experience they are having but still be present with each other in a virtual space of two or more different VR environments. Note that one of the users 202 may see the jungle scene while the other user 202 sees the medieval scene. Being in the same environment does not need to be a deciding factor in which virtual environment the users are placed in but it can be.

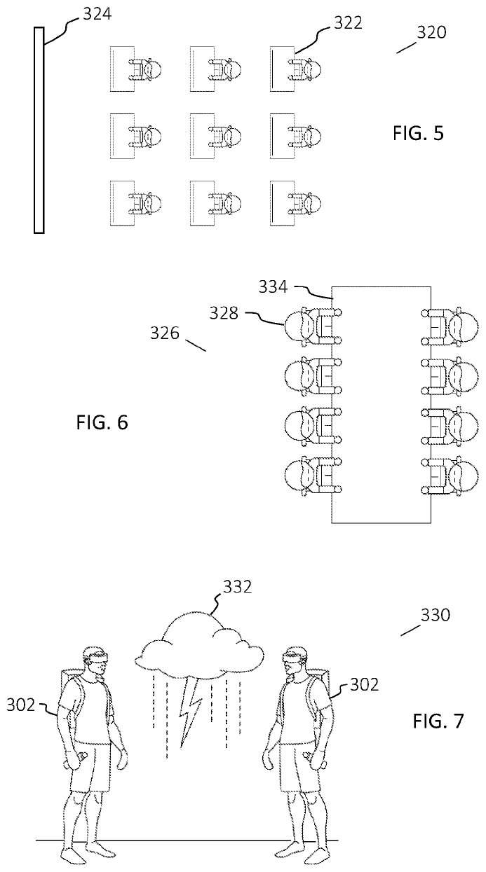

The concepts presented herein can be extended to a virtual educational setting 320 as shown in FIG. 5 where student 3D models 322 are present in a virtual classroom and see concepts presented on a virtual board 324 by a real or virtual instructor (not shown). Student 3D models 322 can raise their arms to ask questions and go draw on the virtual board 324 just like they would in person.

The concepts presented herein can be extended to several applications in VR like virtual meeting rooms. For example, the concept can be applied to virtual meeting rooms by having users tracked and mapped into a virtual meeting room with many other virtual attendees. The room can be a real or virtual meeting room mapped into a VR environment that will join all tracked users into the same or virtual place. Each user can be in a different physical place while attending the meeting but still be virtually present with all other attendees. A virtual meeting room is shown in FIG. 6 with employee 3D models 328 gathered at a virtual table 334 in a virtual corporate setting 326.

An MR environment is shown in FIG. 7, where users 302 appear as likenesses of themselves and the environment 330 appears the same as they do in the actual physical environment in which the users 302 are currently in to show the actual portion of the mixed reality. A bolt of lightning 332 that flashes between the users 302 creates the virtual portion of the MR the environment.

An endless array of possibilities await the creation of a virtual experience. For example, one user may appear as a likeness of themselves while another user appears as a 3D model or as a different type of entity altogether (e.g., animal, inanimate object, etc.). Environments may be the same or different to each user, including mixed reality being only apparent to certain users and not others. This allows imaginative play and creative ways of leading the user through a virtual environment.

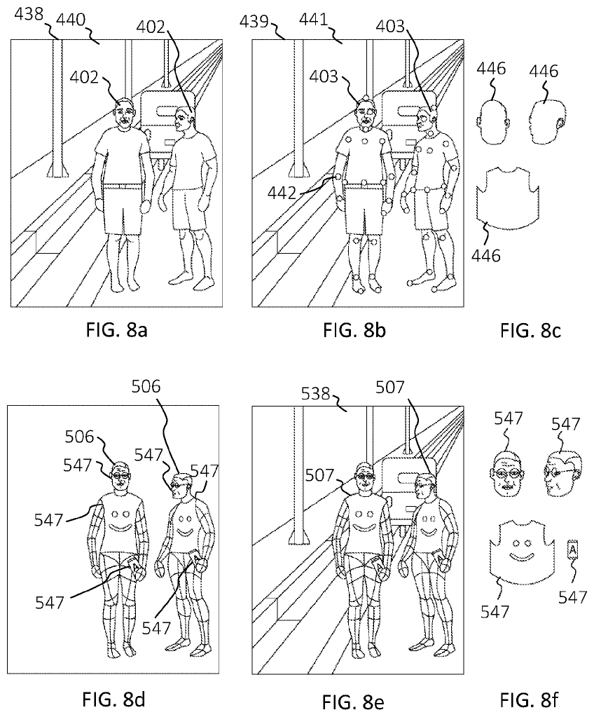

FIGS. 8a, 8b, 8c, 8d, 8e, and 8f illustrate concepts related to creating 3D models from RGB images and rendering textures on 3D models. FIG. 8a shows an example input RGB image 438 taken of two individuals 402 in an example physical environment 440. The two individuals 402 may or may not be accessing the VR environment for a game or other type of VR use.

In FIG. 8b, a representation 439 of processing data (e.g., individuals, environment, etc.) of the input RGB image 438 is shown. This can be an automated process whereby data is collected from the input RGB image 438 and is used to provide a virtual rendering. The surface of the image is broken into parts which are parameterized with a local two-dimensional (2D) system.

The representation 439 in FIG. 8b illustrates processing of the users 403 in a duplicate physical environment 441. The representation 439 shows users 403 which are the same users 402 on the RGB image 438 with sample points 442, for example, selections of one or more pixels, taken at various locations of their bodies. Sample points may further be taken of the environment 438 or other areas of interest.

The RGB image 438 may be segmented, or otherwise partitioned, to define common body parts (e.g., arms, legs, clothing area, etc.) 446 or other areas as desired as represented by FIG. 8c. Example body parts 446 shown include two faces and a shirt. The sample points shared within areas as the body parts and the body parts themselves can be brought into correspondence with their locations on a model mesh surface or other type of surface. The sample points may be used to form the model mesh surface. The 3D model may be made by corresponding image pixels of the body parts to locations on a mesh model, or be used to formulate a 3D model, to provide a surface representation of the user's body. It is further anticipated that body parts can be matched with other body parts but without any kind of mesh model or base model.

Different techniques are anticipate for modeling. Object detection and object classification techniques may be used. Object detection is used to correctly label a dominant object in an image. Object classification is used to provide a correct label and location of objects in an image. Object detection may incorporate regions of interest (RoIs) pooling to match sample points with body parts. A region of interest includes a number of samples within a data set that are identified for a particular purpose, such as a data set that may represent an area of the body (e.g., arm, leg, face, hand, etc.). Region of interest pooling (RoI pooling) is an operation widely used in object detection tasks using convolutional neural networks.

Image annotation is performed to classify information that is of relevance to an image. For example, segmentation is a form of image annotation that partitions or labels body parts so that an association or correspondence can be made between image pixels and the object of the body. The partitions or labels are used for surface coordinate prediction on 3D models.

3D pose estimation techniques may be used to determine the transformation of the object in a 2D image into the 3D object. For example, there exist environments where it is difficult to extract corners or edges from an mage. To circumvent these issues, the object is dealt with as a whole through the use of free-form contours. Also, dense human pose estimation techniques can be used.

Regression techniques can be performed for coordinate predictions on the 3D model and assignments can be made where each pixel within the body part should be assigned to the 3D model.

A set of images may be used for correspondence. In one example, a set of six rendered views of the same face but with each face directed at a different angle (e.g., front view, side view, angled view, etc.) may be provided and the body part of the user can be matched with one of the images to help correspond a sample point within the body part with the appropriate location on the face. Each view includes surface coordinates, and the surface coordinates can be used to localize the collected 2D points on the 3D model. This technique along with others can be used so that each pixel of an image can be associated with a unique surface coordinate of a 3D model.

Manipulated surfaces or texture using data from the original image or other information can be drawn over the body parts 547 to create an avatar or other computerized image. For example, body parts can be manipulated so that they appear different from how they appeared in an original image to change the body appearance in the original image. As shown in FIG. 8f, the body parts 446 of the face have been manipulated to add glasses to the faces of the original body face area. The shirt area 446 has been manipulated in form to show a happy face on the front side. The manipulated body parts 547 are represented in FIG. 8f.

Corresponding body parts 446 to a 3D model 506 in real-time provides an approach for mapping all human pixels of two-dimensional (2D) RGB images to 3D surface-based models of bodies. Each model may be made of surface coordinates where each pixel can be associated with a unique surface coordinate. In FIG. 8d, the manipulated body parts 547 have been added to 3D models 506 of the users 402. The 3D models may convey information including, but not limited to, contour and depth information, represented with mesh lines and color.

Textures can be applied to one or more 3D models. A texture may include body parts from the original image or manipulated model surfaces as discussed above. Alternatively, textures may include information from other images and other manipulated model surfaces. Information that is not related to the original image may be applied. Textures allow creative application modeling to enhance the virtual experience.

FIG. 8e shows the 3D models 506 placed within a VR environment 538 to finish the VR experience. Inanimate objects, such as the can 546 with the letter A on front, can also be added to the VR environment. Also, the image data from one user can be manipulated so that at least one of a texture, an avatar, a custom appearance, and a shape from the image data can be applied to another user or 3D model.

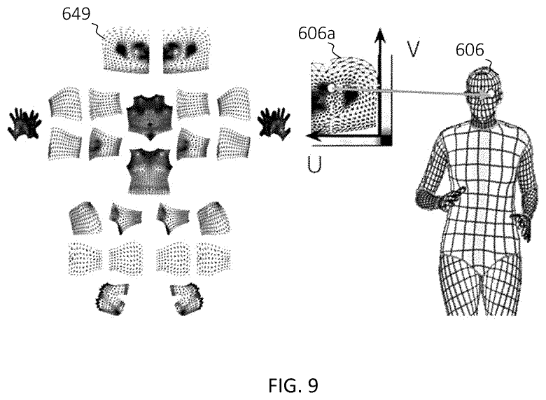

A surface can be broken into many body parts that will be correlated to the body areas found in the original image. FIG. 9 shows an example of body parts 649 that are available to form a mesh model 606 or 3D model. A correspondence is made between body parts 649 and sample points of image pixels from the original image (not shown). A close-up view of the body part of an eye area 606a body part is used to add image data to the 3D model 606.

The process can be implemented automatically and in real time to provide a dynamic experience for the user. For example, operations may include handling multiple frames per second on a single GPU and include tens or even hundreds of humans simultaneously.

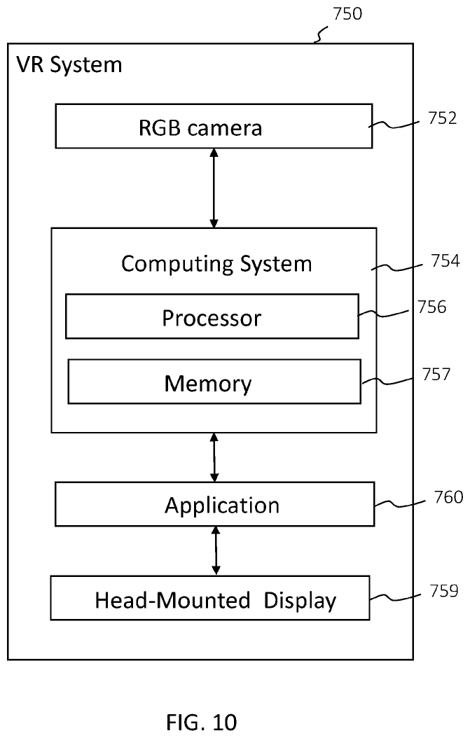

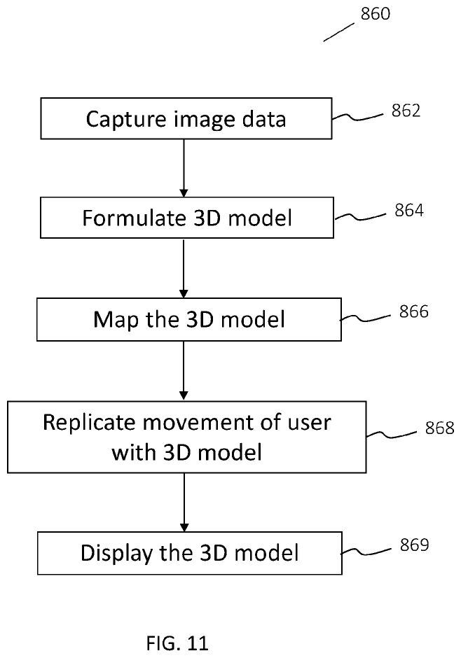

FIG. 10 illustrates an example VR system 750 used to implement principles discussed herein, including an RGB camera 752, a computing system 754, and a visual display 759. The computing system 752 includes a processor 756 to perform various functions described herein and memory 757 to store related data. Various machine-readable instructions may be executed by the processor 756. The modules can include general or special purpose hardware, firmware, or software embodied in a computer readable storage medium for execution by the processor. As used herein, a computer-readably medium or computer-readable storage medium includes hardware (e.g., registers, random access memory (RAM), and nonvolatile (NV) storage, etc.) and is represented by memory 757 in the computing system 754. The processor 756 and its various modules may be used to perform functions that are used to create the 3D models, track the movement of users, and render 3D models that perform the movements.

An HMD 759 is included in the VR system 750 to provide visual information to the user. The information can include a 3D model of the user that has movement associated with movement of the user. The movement of the 3D model may be simultaneous or nearly simultaneous with the movement of the user. Alternatively, movement of the user may be displayed as movements performed by other figures or objects on the HMD. Moreover, the user's movements may be related to more than one figure or object on the display at the same time or at other times throughout a VR experience. Visual information may be available through various displays, such as through a display screen, glasses, wrist device (e.g., wrist watch, bracelet, wristband, etc.), headset, hologram, or other type of visual system. The visual display 759 may be worn by the user (e.g., on head, shoulders, arms) or be independently displayed to the user and not physically supported by the user.

Visual information may include an interaction of the 3D model with one or more virtual objects, where information pertaining to the interaction may be received from an application 760. The example VR system 750 shown includes application 760, which may be a device or software application and which provides a game or other type of program facilitating the user's interaction and 3D model movement within the VR system 750. The application 760 makes use of the various information provided by the RGB camera as well as other information that may be available such as audio information, information from other cameras or other tracking devices, or information made available by interfacing with other device or software applications.

A flow diagram 860 illustrates an example process of incorporating a mesh model or 3D model into the VR system 750 and will be discussed as it relates to elements of the VR system in FIG. 9. At block 862, image data is captured by an RGB camera 752 or other form of image acquisition that is known and available in the art. The image data is processed at block 864 by the computing system 754 to formulate a mesh model or 3D model. This may include procedures discussed above, including obtaining sample pixel points of data, such as sample points in ROIs, and segmenting the sample points in ROIs to represent body parts. The body parts may be corresponded to model surfaces of a mesh model or 3D model. Furthermore, textures, such as body parts that are manipulated in some manner, or alternative model surfaces that may be corresponded to model surfaces, can be applied to the of a mesh model or 3D model.

At block 866, the computing system 754 maps the 3D model to a virtual environment like the ones described in FIGS. 2b, 4a, 4b, 5, 6, 7, and 8e and the information is communicated to the user via a visual display 759.

By obtaining additional images through multiple image acquisition (e.g., video recording, etc.), the computing system 754 is able to show shifts in position of the 3D model that replicate movement of the 3D model corresponding to movement of the user. This is represented by block 868. At block 869, the movement of the 3D model is displayed to the user. While reference is made to the computing system 754, note that the application 760 may be made to perform all or some of the various acts described in the flow diagram 860.

What is claimed is:

1. A virtual reality (VR) system for providing real time user interaction, comprising:
at least one red, green, blue (RGB) camera to capture image data of a user's body in a physical environment;
a processor to receive the image data to formulate a three-dimensional (3D) model of the user's body and to map the 3D model inside a VR environment; and
a head-mounted display (HMD) to display the 3D model and movements of the 3D model within the VR environment.

2. The VR system in claim 1, wherein the processor is contained within a VR portable device that is worn by the user.

3. The VR system in claim 1, wherein the VR environment includes at least one of a gaming environment, a meeting room, an educational setting, or a mixed reality environment.

4. The VR system in claim 1, wherein the VR system is to add at least one additional user tracked in the physical environment of the user or a different physical environment tracked by a different RGB camera.

5. The VR system in claim 1, wherein the 3D model is made by corresponding image pixels to locations on a model to provide a surface representation of the user's body.

6. A method of providing real time user interaction in an augmented reality (AR) environment, comprising:
with three-dimensional (3D) tracking, capturing image data of the user's body in a physical environment;
formulating a 3D model of a user's body with the image data;
mapping the 3D model inside an AR environment;
replicating at least one body movement of the user using the 3D model within the AR environment; and
mapping the 3D model inside an AR environment that is visible to a user wearing a head-mounted display (HMD).

7. The method of claim 6, wherein capturing image data of at least one movement of the user's body is to be performed by at least one RGB camera strategically positioned within the physical environment of the user.

8. The method of claim 6, further comprising manipulating the image data by applying at least one of a texture, an avatar, a custom appearance, and a shape to the 3D model.

9. The method of claim 6, further comprising manipulating the image data by applying at least one of a texture, an avatar, a custom appearance, and a shape to another user or 3D model.

10. The method in claim 6, wherein the AR system is to add at least one additional user tracked in the physical environment of the user or a different physical environment tracked by a different RGB camera.

11. The method of claim 6, wherein the AR environment includes at least one of a gaming environment, a meeting room, an educational setting, or a mixed reality environment.

12. The method of claim 6, further comprising adding at least one additional user from the same physical environment as the user or from a different physical environment and using a different form of 3D tracking.

13. The method of claim 6, further comprising providing the at least one additional user with a same or different AR environment as the user.

14. A non-transitory computer readable medium comprising computer usable program code embodied therewith, the computer usable program code to, when executed by a processor:
with three-dimensional (3D) tracking, capture image data of the user's body in a physical environment;
formulate a 3D model of a user's body with the image data;
map the 3D model inside a virtual reality (VR) environment;
replicate at least one or more body movements of the user using the 3D model within the VR environment; and
render the 3D model and VR environment visible to a user wearing a head-mounted display (HMD).

15. The computer readable medium of claim 13 wherein the 3D data is manipulated by applying at least one of a texture, an avatar, a custom appearance, and a shape to the 3D model.
